(19) United States
(12) Patent Application Publication
(10) Pub. No.: US 2022/0169263 A1
(43) Pub. Date: Jun. 2, 2022

(54) SYSTEMS AND METHODS FOR PREDICTING A VEHICLE TRAJECTORY

(71) Applicant: BEIJING VOYAGER TECHNOLOGY CO., LTD., Beijing (CN)

(72) Inventors: You LI, Beijing (CN); Jian GUAN, Beijing (CN); Pei LI, Beijing (CN)

(73) Assignee: BEIJING VOYAGER TECHNOLOGY CO., LTD., Beijing (CN)

(21) Appl. No.: 17/674,787

(22) Filed: Feb. 17, 2022

Related U.S. Application Data
(63) Continuation of application No. PCT/CN2019/109354, filed on Sep. 30, 2019.

(51) Int. Cl. B60W 50/00; B60W 40/04; G08G 1/052; G08G 1/01; G06V 20/58; G06V 10/44; G06T 7/73; G06V 20/56

(52) U.S. Cl. CPC B60W 50/0097; B60W 40/04; G08G 1/052; G08G 1/0104; G01S 17/931; G06V 10/44; G06T 7/73; G06V 20/588; G06V 20/58

(57) ABSTRACT

Embodiments of the disclosure provide methods and systems for predicting a trajectory of a vehicle. An exemplary system includes a communication interface configured to receive a map of an area in which the vehicle is traveling and sensor data acquired associated with the vehicle. The system includes at least one processor configured to position the vehicle in the map and identify one or more objects surrounding the vehicle based on the positioning of the vehicle. The at least one processor is further configured to extract features of the vehicle and the one or more objects from the sensor data. The at least one processor is also configured to determine a plurality of candidate trajectories, determine a probability for each candidate trajectory based on the extracted features, and identify the candidate trajectory with the highest probability as the predicted trajectory of the vehicle.

### CROSS REFERENCE TO RELATED APPLICATIONS

This application is a bypass continuation to PCT Application No. PCT/CN2019/109354, filed Sep. 30, 2019. The present application is also related to PCT Application Nos. PCT/CN2019/109350, PCT/CN2019/109352, and PCT/CN2019/109351, each filed Sep. 30, 2019. The entire contents of all of the above-identified applications are incorporated herein by reference in their entireties.

### TECHNICAL FIELD

The present disclosure relates to systems and methods for predicting a vehicle trajectory, and more particularly, to systems and methods for predicting a vehicle trajectory using features extracted from map and sensor data.

### BACKGROUND

Vehicles share roads with other vehicles, bicycles, pedestrians, and objects, such as traffic signs, road blocks, fences, etc. Therefore, drivers need to constantly adjust driving to avoid colliding the vehicle with such obstacles. While some obstacles are generally static and therefore easy to avoid, some others might be moving. For a moving obstacle, the driver has to not only observe its current position but to predict its moving trajectory in order to determine its future positions. For example, another vehicle on the road coming towards the vehicle may go straight, stop, or make turns. The driver typically makes the prediction based on observations such as turn signals provided by the coming vehicle, the vehicle's traveling speed, etc.

Automatous driving vehicles need to make similar decisions to avoid obstacles. Therefore, automatous driving technology relies heavily on automated prediction of other vehicles' trajectories. However, existing prediction systems and methods are limited by the vehicle's ability to “see” (e.g., to collect relevant data), ability to process the data, and ability to make accurate predictions based on the data. Accordingly, automatous driving vehicles can benefit from improvements to the existing prediction systems and methods.

Embodiments of the disclosure improve the existing prediction systems and methods in automatous driving by providing systems and methods for predicting a vehicle trajectory using features extracted from map and sensor data.

### SUMMARY

Embodiments of the disclosure provide a system for predicting a trajectory of a vehicle. The system includes a communication interface configured to receive a map of an area in which the vehicle is traveling and sensor data acquired associated with the vehicle. The system includes at least one processor configured to position the vehicle in the map and identify one or more objects surrounding the vehicle based on the positioning of the vehicle. The at least one processor is further configured to extract features of the vehicle and the one or more objects from the sensor data. The at least one processor is also configured to determine a plurality of candidate trajectories, determine a probability for each candidate trajectory based on the extracted features, and identify the candidate trajectory with the highest probability as the predicted trajectory of the vehicle.

Embodiments of the disclosure also provide a method for predicting a trajectory of a vehicle. The method includes receiving, by a communication interface, a map of an area in which the vehicle is traveling and sensor data acquired associated with the vehicle. The method further includes positioning, by at least one processor, the vehicle in the map and identifying, by the at least one processor, one or more objects surrounding the vehicle based on the positioning of the vehicle. The method also includes extracting, by the at least one processor, features of the vehicle and the one or more objects from the sensor data. The method additionally includes determining, by the at least one processor, a plurality of candidate trajectories, determining, by the at least one processor, a probability for each candidate trajectory based on the extracted features, and identifying the candidate trajectory with the highest probability as the predicted trajectory of the vehicle.

Embodiments of the disclosure further provide a non-transitory computer-readable medium having instructions stored thereon that, when executed by at least one processor, causes the at least one processor to perform operations. The operations include receiving a map of an area in which the vehicle is traveling and sensor data acquired associated with the vehicle. The operations further include positioning the vehicle in the map and identifying one or more objects surrounding the vehicle based on the positioning of the vehicle. The operations further include extracting features of the vehicle and the one or more objects from the sensor data. The operations also include determining a plurality of candidate trajectories, determining a probability for each candidate trajectory based on the extracted features, and identifying the candidate trajectory with the highest probability as the predicted trajectory of the vehicle.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary cross-road and exemplary vehicles traveling therein, according to embodiments of the disclosure.

FIG. 2 illustrates a schematic diagram of an exemplary system for predicting a vehicle trajectory, according to embodiments of the disclosure.

FIG. 3 illustrates an exemplary vehicle with sensors equipped thereon, according to embodiments of the disclosure.

FIG. 4 is a block diagram of an exemplary server for predicting a vehicle trajectory, according to embodiments of the disclosure.

FIG. 5 is a flowchart of an exemplary method for predicting a vehicle trajectory, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

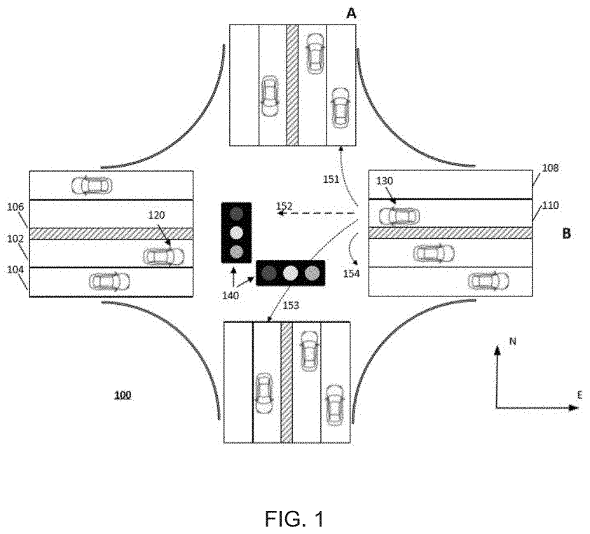

FIG. 1 illustrates a schematic diagram of an exemplary cross-road 100 and exemplary vehicles (e.g., vehicles 120 and 130) traveling therein, according to embodiments of the disclosure. As shown in FIG. 1, cross-road 100 includes two roads, one is shown in the vertical direction (referred to as “road A”) and another is shown in the horizontal direction (referred to as “road B”), crossing each other, and traffic lights 140 at the crossing. For ease of description, road A is illustrated to extend in the North-South direction, and road B is illustrated to extend in the East-West direction. It is contemplated that roads A and B can extend in any other directions, and are not necessarily perpendicular to each other.

Each of road A and road B is shown as a two-way road. For example, road B includes first direction lanes 102 and 104 and second direction lanes 108 and 110. The first and second directions may be opposite to each other and separated by a divider 106. It is contemplated that one or both of the roads may be one-way and/or have more or less lanes.

Various vehicles may be traveling on the roads in both directions. For example, vehicle 120 may be traveling east-bound on first direction lane 102, and vehicle 130 may be traveling west-bound on second direction lane 103. In some embodiments, vehicles 120 and 130 may be electric vehicles, fuel cell vehicles, hybrid vehicles, or conventional internal combustion engine vehicles. In some embodiments, vehicle 120 may be an autonomous or semi-autonomous vehicle.

The vehicle traffic at cross-road 100 may be regulated by traffic lights 140. Traffic lights 140 may be installed in one or both directions. In some embodiments, traffic lights 140 may include lights in three colors: red, yellow and green, to signal the right of way at cross-road 100. In some embodiments, traffic lights 140 may additionally include turn protection lights to regulate the left, right, and/or U-turns at cross-road 100. For example, a left turn protection light may allow vehicles in certain lanes (usually the left-most lane) to turn left without having to yield to vehicles traveling straight in the opposite direction.

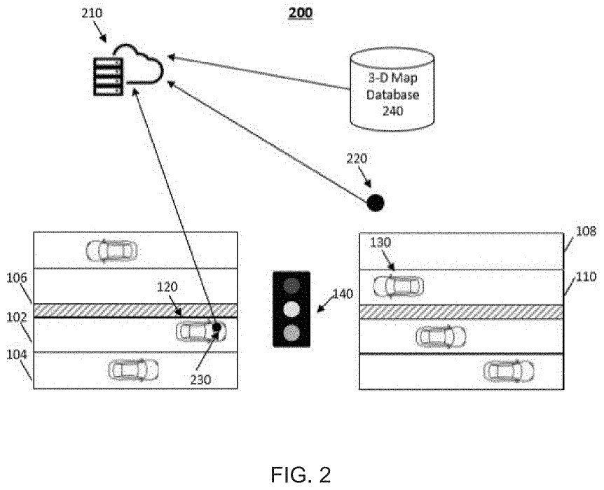

In some embodiments, vehicle 120 may be equipped with or in communication with a vehicle trajectory prediction system (e.g., system 200 shown in FIG. 2) to predict the trajectory of another vehicle on the road, such as vehicle 130, in order to make decisions to avoid that vehicle in its own travel path. For example, vehicle 130 may possibly travel in four candidate trajectories: a candidate trajectory 151 to make a right-turn, a candidate trajectory 152 to go straight, a candidate trajectory 153 to make a left-turn, and a candidate trajectory 154 to make a U-turn. Consistent with embodiments of the present disclosure, the vehicle trajectory prediction system may make “observations” (e.g., through various sensors) of vehicle 130 and the surrounding objects, such as traffic light(s) 140, traffic signs at cross-road 100, and other vehicles on the roads, etc. The vehicle trajectory prediction system then makes a prediction which candidate trajectory vehicle 130 may likely follow based on these observations. In some embodiments, the prediction may be preformed using a learning model, such as a neural network. In some embodiments, probabilities may be determined for the respective candidate trajectories 151-154.

FIG. 2 illustrates a schematic diagram of an exemplary system 200 for predicting a vehicle trajectory, according to embodiments of the disclosure. System 200 may be used in cross-road 100 illustrated in FIG. 1 or similar settings. For ease of illustration, a simplified cross-road setting is used in FIG. 2. However, it is understood that system 200 is also applicable in other cross-road settings. System 200 may include a vehicle trajectory prediction server 210 (also referred to as server 210 for simplicity). Server 210 can be a general-purpose server configured or programmed to predict vehicle trajectories or a proprietary device specially designed for predicting vehicle trajectories. It is contemplated that server 210 can be a stand-alone server or an integrated component of a stand-alone server. In some embodiments, server 210 may be integrated into a system onboard a vehicle, such as vehicle 120.

As illustrated in FIG. 2, server 210 may receive and analyze data collected by various sources. For example, data may be continuously, regularly, or intermittently captured by one or more sensors 220 equipped along a road and/or one or more sensors 230 equipped on vehicle 120 driving through lane 102. Sensors 220 and 230 may include radars, LiDARs, cameras (such as surveillance cameras, monocular/binocular cameras, video cameras), speedometers, or any other suitable sensors to capture data characterizing vehicle 130 and objects surrounding vehicle 130, such as traffic light 140. For example, sensors 220 may include one or more surveillance cameras that capture images of vehicle 130 and traffic light 140.

In some embodiments, sensors 230 may include a LiDAR that measures a distance between vehicle 120 and vehicle 130, and the position of vehicle 130 in a 3-D map. In some embodiments sensor 230 may also include a GPS/IMU (inertial measurement unit) sensor to capture position/pose data of vehicle 120. In some embodiments, sensors 230 may additionally include cameras to capture images of vehicle 130 and traffic light 140. Since the images captured by sensors 220 and sensors 230 are from different angles, they may supplement each other to provide more detailed information of vehicle 130 and surrounding objects. In some embodiments, sensors 220 and 230 may acquire data that tracks the trajectories of moving objects, such as vehicles, pedestrians, etc.

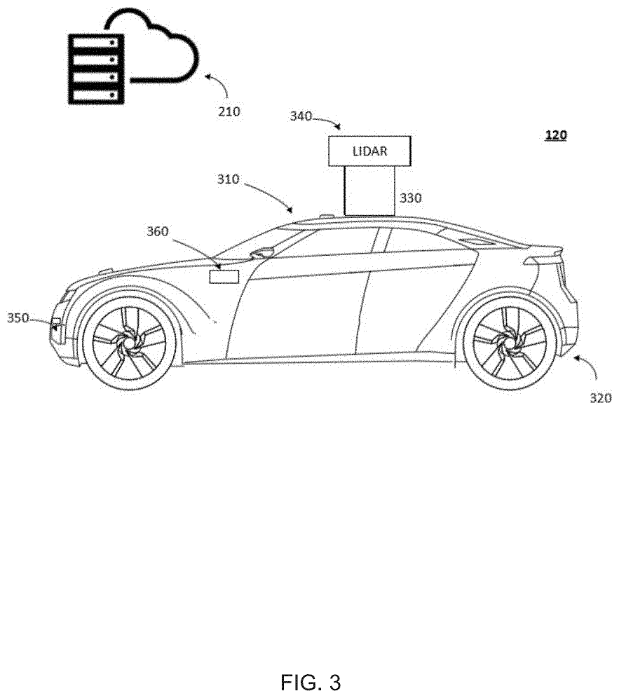

In some embodiments, sensors 230 may be equipped on vehicle 120 and thus travel with vehicle 120. For example, FIG. 3 illustrates an exemplary vehicle 120 with sensors 340-360 equipped thereon, according to embodiments of the disclosure. Vehicle 120 may have a body 310, which may be any body style, such as a sports vehicle, a coupe, a sedan, a pick-up truck, a station wagon, a sports utility vehicle (SUV), a minivan, or a conversion van. In some embodiments, vehicle 120 may include a pair of front wheels and a pair of rear wheels 320, as illustrated in FIG. 3. However, it is contemplated that vehicle 120 may have less wheels or equivalent structures that enable vehicle 120 to move around. Vehicle 120 may be configured to be all wheel drive (AWD), front wheel drive (FWR), or rear wheel drive (RWD). In some embodiments, vehicle 120 may be configured to be an autonomous or semi-autonomous vehicle.

As illustrated in FIG. 3, sensors 230 of FIG. 2 may include various kinds of sensors 340, 350, and 360, according to embodiments of the disclosure. Sensor 340 may be mounted to body 310 via a mounting structure 330. Mounting structure 330 may be an electro-mechanical device installed or otherwise attached to body 310 of vehicle 120. In some embodiments, mounting structure 330 may use screws, adhesives, or another mounting mechanism. Vehicle 120 may be additionally equipped with sensors 350 and 360 inside or outside body 310 using any suitable mounting mechanisms. It is contemplated that the manners in which sensors 340-360 can be equipped on vehicle 120 are not limited by the example shown in FIG. 3 and may be modified depending on the types of sensors 340-360 and/or vehicle 120 to achieve desirable sensing performance.

Consistent with some embodiments, sensor 340 may be a LiDAR that measures the distance to a target by illuminating the target with pulsed laser lights and measuring the reflected pulses. Differences in laser return times and wavelengths can then be used to make digital 3-D representations of the target. For example, sensor 340 may measure the distance between vehicle 120 and vehicle 130 or other objects. The light used for LiDAR scan may be ultraviolet, visible, or near infrared. Because a narrow laser beam can map physical features with a very high resolution, a LiDAR scanner is particularly suitable for positioning objects in a 3-D map. For example, a LiDAR scanner may capture point cloud data, which may be used to position vehicle 120, vehicle 130 and/or other objects.

In some embodiments, sensors 350 may include one or more cameras mounted on body 310 of vehicle 120. Although FIG. 3 shows sensors 350 as being mounted at the front of vehicle 120, it is contemplated that sensors 350 may be mounted or installed at other positions of vehicle 120, such as on the sides, behind the mirrors, on the windshields, on the racks, or at the rear end. Sensors 350 may be configured to capture images of objects surrounding vehicle 120, such as other vehicles on the roads (including, e.g., vehicle 130), traffic light(s) 140, and/or traffic signs. In some embodiments, the cameras may be monocular or binocular cameras. The binocular cameras may acquire data indicating depths of the objects (i.e., the distances of the objects from the cameras). In some embodiments, the cameras may be video cameras that capture image frames over time, thus recording the movements of the objects.

As illustrated in FIG. 3, vehicle 120 may be additionally equipped with sensor 360, which may include sensors used in a navigation unit, such as a GPS receiver and one or more IMU sensors. A GPS is a global navigation satellite system that provides geolocation and time information to a GPS receiver. An IMU is an electronic device that measures and provides a vehicle's specific force, angular rate, and sometimes the magnetic field surrounding the vehicle, using various inertial sensors, such as accelerometers and gyroscopes, sometimes also magnetometers. By combining the GPS receiver and the IMU sensor, sensor 360 can provide real-time pose information of vehicle 120 as it travels, including the positions and orientations (e.g., Euler angles) of vehicle 120 at each time point.

Consistent with the present disclosure, sensors 340-360 may communicate with server 210 via a network to transmit the sensor data continuously, or regularly, or intermittently. In some embodiments, any suitable network may be used for the communication, such as a Wireless Local Area Network (WLAN), a Wide Area Network (WAN), wireless communication networks using radio waves, a cellular network, a satellite communication network, and/or a local or short-range wireless network (e.g., Bluetooth™).

Referring back to FIG. 2, although FIG. 2 only illustrates sensors 230 equipped on vehicle 120, it is contemplated that similar sensors may also be equipped on other vehicles on the roads, including vehicle 130. For example, vehicle 130 may be equipped with a LiDAR, one or more cameras, and/or a GPS/IMU sensor. These sensors may also communicate with server 210 to provide additional sensor data to aid the prediction.

As shown in FIG. 2, system 200 may further include a 3-D map database 240. 3-D map database 240 may store 3-D maps. The 3-D maps may include maps that cover different regions and areas. For example, a 3-D map (or map portion) may cover the area of cross-road 100. In some embodiments, server 210 may communicate with 3-D map database 240 to retrieve a relevant 3-D map (or map portion) based on the position of vehicle 120. For example, map data containing the GPS position of vehicle 120 and its surrounding area may be retrieved. In some embodiments, 3-D map database 240 may be an internal component of server 210. For example, the 3-D maps may be stored in a storage of server 210. In some embodiments, 3-D map database 240 may be external of server 210 and the communication between 3-D map database 240 and server 210 may occur via a network, such as the various kinds of networks described above.

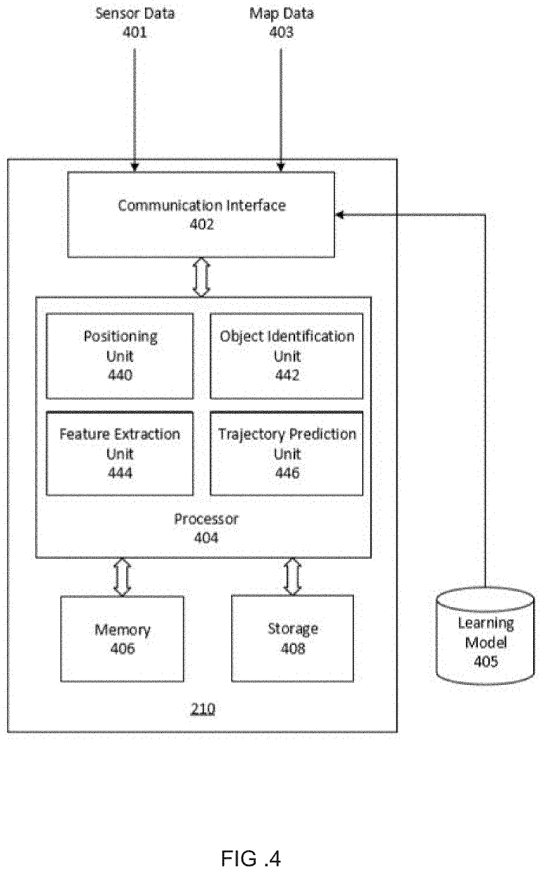

Server 210 may be configured to analyze the sensor data received from sensors 230 (e.g., sensors 340-360) and the map data received from 3-D map database 240 to predict the trajectories of other vehicles on the roads, such as vehicle 130. FIG. 4 is a block diagram of an exemplary server 210 for predicting a vehicle trajectory, according to embodiments of the disclosure. Server 210 may include a communication interface 402, a processor 404, a memory 406, and a storage 408. In some embodiments, server 210 may have different modules in a single device, such as an integrated circuit (IC) chip (implemented as an application-specific integrated circuit (ASIC) or a field-programmable gate array (FPGA)), or separate devices with dedicated functions. Components of server 210 may be in an integrated device, or distributed at different locations but communicate with each other through a network (not shown).

Communication interface 402 may send data to and receive data from components such as sensors 220 and 230 via direct communication links, a Wireless Local Area Network (WLAN), a Wide Area Network (WAN), wireless communication networks using radio waves, a cellular network, and/or a local wireless network (e.g., Bluetooth or WiFi), or other communication methods. In some embodiments, communication interface 402 can be an integrated services digital network (ISDN) card, cable modem, satellite modem, or a modem to provide a data communication connection. As another example, communication interface 402 can be a local area network (LAN) card to provide a data communication connection to a compatible LAN. Wireless links can also be implemented by communication interface 402. In such an implementation, communication interface 402 can send and receive electrical, electromagnetic or optical signals that carry digital data streams representing various types of information via a network.

Consistent with some embodiments, communication interface 402 may receive sensor data 401 acquired by sensors 220 and/or 230, as well as map data 403 provided by 3-D map database 240, and provide the received information to memory 406 and/or storage 408 for storage or to processor 404 for processing. Sensor data 401 may include information capturing vehicles (such as vehicle 130) and other objects surrounding the vehicles. Sensor data 401 may contain data captured over time that characterize the movements of the objects. In some embodiments, map data 403 may include point cloud data.

Communication interface 402 may also receive a learning model 405. In some embodiments, learning model 405 may be applied by processor 404 to predict vehicle trajectories based on features extracted from sensor data 401 and map data 403. In some embodiments, learning model 405 may be a predictive model, such as a decision tree learning model. A decision tree uses observations of an item (represented in the branches) to predict a target value of the item (represented in the leaves). In some embodiments, gradient boosting may be combined with the decision tree learning model to form a prediction model as an ensemble of decision trees. For example, learning model 405 may become a Gradient Boosting Decision Tree model formed with stage-wise decision trees.

In some embodiments, learning model 405 may be trained using known vehicle trajectories and their respective sample features, such as semantic features including the vehicle speed, the lane markings of vehicle lane, the status of the traffic light, the orientation of the vehicle, vehicle turn signals, vehicle breaking signals, etc. The sample features may additionally include non-semantic features extracted from data descriptive of the vehicle movements. In some embodiments, learning model 405 may be trained by server 210 or another computer/server ahead of time.

Processor 404 may include any appropriate type of general-purpose or special-purpose microprocessor, digital signal processor, or microcontroller. Processor 404 may be configured as a separate processor module dedicated to predicting vehicle trajectories. Alternatively, processor 404 may be configured as a shared processor module for performing other functions related to or unrelated to vehicle trajectory predictions. For example, the shared processor may further make autonomous driving decision based on the predicted vehicle trajectories.

As shown in FIG. 4, processor 404 may include multiple modules, such as a positioning unit 440, an object identification unit 442, a feature extraction unit 444, a trajectory prediction unit 446, and the like. These modules (and any corresponding sub-modules or sub-units) can be hardware units (e.g., portions of an integrated circuit) of processor 404 designed for use with other components or to execute part of a program. The program may be stored on a computer-readable medium (e.g., memory 406 and/or storage 408), and when executed by processor 404, it may perform one or more functions. Although FIG. 4 shows units 440-446 all within one processor 404, it is contemplated that these units may be distributed among multiple processors located near or remotely with each other.

Positioning unit 440 may be configured to position the vehicle whose trajectory is being predicted (e.g., vehicle 130) in map data 403. In some embodiments, sensor data 401 may contain various data captured of the vehicle to assist the positioning. For example, LiDAR data captured by sensor 340 mounted on vehicle 120 may reveal the position of vehicle 130 in the point cloud data. In some embodiments, the point cloud data captured of vehicle 130 may be matched with map data 401 to determine the vehicle's position. In some embodiments, positioning methods such as simultaneous localization and mapping (SLAM) may be used to position the vehicle.

In some embodiments, the positions of the vehicle (e.g., vehicle 130) may be labeled on map data 401. For example, a subset of point cloud data P₁ is labeled as corresponding to vehicle 130 at time T₁, a subset of point cloud data P₂ is labeled as corresponding to vehicle 130 at time T₂, and a subset of point cloud data P₃ is labeled as corresponding to vehicle 130 at time T₃, etc. The labeled subsets indicate the existing moving trajectory and moving speed of the vehicle.

Object identification unit 442 may identify objects surrounding the vehicle. These objects may include, e.g., traffic lights 104, traffic signs, lane markings, and other vehicles, etc. In some embodiments, various image processing methods, such as image segmentation, classification, and recognition method, may be applied to identify the objects. In some embodiments, machine learning techniques may also be applied for the identification. Such objects may provide additional information useful to the vehicle trajectory prediction. For example, if the vehicles travelling on a right-turn only lane, it is more likely that it is going to turn right than turning left. Alternatively, if the traffic light regulating the lane is red, the vehicle will likely not move immediately. If there is a no U-turn sign at the crossing, the vehicle is unlikely going to make a U-turn.

Feature extraction unit 444 may be configured to extract features from sensor data 401 and map data 403 that are indicative of a future trajectory of a vehicle. The features extracted may be semantical or non-semantical. Semantical features may include, e.g., the vehicle speed, the lane markings of vehicle lane (indicating a travel restriction of the lane), the status of the traffic light (including the type of light that is on and the color of the light), the vehicle heading direction, vehicle turn signals, vehicle braking signals, etc. Various feature extraction tools may be used, such as image segmentation, object detection, etc. For example, lane markings (e.g., left-turn only arrow, right-turn only arrow, go-straight only arrow, or combination arrows) can be detected from the sensor data based on color and/or contrast information as the markings are usually in white paint and road surface is usually black or gray in color. When color information is available, lane markings can be identified based on their distinct color (e.g., white). When grayscale information is available, lane markings can be identified based on their different shading (e.g., lighter gray) in contrast to the background (e.g., darker gray for regular road pavements). As another example, traffic light signals, vehicle turn signals, and braking signals can be detected by detecting the change (e.g., resulting from blinking, flashing, or color changing) in image pixel intensities. In some embodiments, machine learning techniques may also be applied to extract the feature(s).

Trajectory prediction unit 446 may predict the vehicle trajectory using the extracted features. In some embodiments, trajectory prediction unit 446 may determine a plurality of candidate trajectories, such as candidate trajectories 151-154 for vehicle 130 (shown in FIG. 1). In some embodiments, trajectory prediction unit 446 may apply learning model 405 for the prediction. For example, learning model 405 may determine a probability for each candidate trajectory based on the extracted features. Alternatively, learning model 405 may rank the candidate trajectories by assigning ranking numbers to them. In some embodiments, the candidate trajectory with the highest probability or ranking may be identified as the predicted trajectory of the vehicle.

In some embodiments, before applying learning model 405, trajectory prediction unit 446 may first remove one or more candidate trajectories that conflicts with any of the features. For example, if the vehicle is on a lane with right-turn only lane marking, and the vehicle is signaling a right-turn, a left-turn trajectory and a U-turn trajectory may be eliminated since the probably that the vehicle will turn left or make a U-turn under such conditions is substantially low. As another example, if the vehicle is on the left-most lane and signaling a left-turn, but a traffic sign forbids a U-turn, the U-turn trajectory may be eliminated. By removing certain candidate trajectories, trajectory prediction unit 446 simplifies the prediction task and conserves processing power of processor 404.

In some embodiments, trajectory prediction unit 446 may compare the determined probabilities for the respective candidate trajectories with a threshold. If none of the candidate trajectory has a probability exceeding the threshold, trajectory prediction unit 446 may determine that the prediction is not sufficiently reliable and additional “observations” are necessary to improve the prediction. In some embodiments, trajectory prediction unit 446 may determine what additional sensor data can be acquired and generate control signals to be transmitted to sensors 220 and/or 230 for capturing the additional data. For example, it may be determined that the LiDAR should be tilted at a different angle or that the camera should adjust its focal point. The control signal may be provided to sensors 220 and/or 230 via communication interface 402.

Memory 406 and storage 408 may include any appropriate type of mass storage provided to store any type of information that processor 404 may need to operate. Memory 406 and storage 408 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 406 and/or storage 408 may be configured to store one or more computer programs that may be executed by processor 404 to perform vehicle trajectory functions disclosed herein. For example, memory 406 and/or storage 408 may be configured to store program(s) that may be executed by processor 404 to predict the vehicle trajectory based on features extracted from the sensor data 401 captured by various sensors 220 and/or 230, and map data 403.

Memory 406 and/or storage 408 may be further configured to store information and data used by processor 404. For instance, memory 406 and/or storage 408 may be configured to store sensor data 401 captured by sensors 220 and/or 230, map data 403 received from 3-D map database 240, and learning model 405. Memory 406 and/or storage 408 may also be configured to store intermediate data generated by processor 404 during feature extraction and trajectory prediction, such as the features, the candidate trajectories, and the calculated probabilities for the candidate trajectories. The various types of data may be stored permanently, removed periodically, or disregarded immediately after each frame of data is processed.

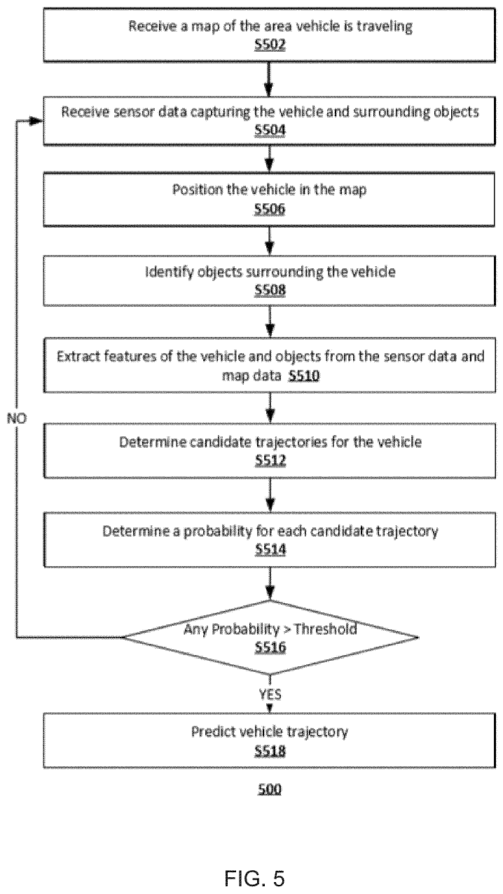

FIG. 5 illustrates a flowchart of an exemplary method 500 for predicting a vehicle trajectory, according to embodiments of the disclosure. For example, method 500 may be implemented by system 200 that includes, among other things, server 210 and sensors 220 and 230. However, method 500 is not limited to that exemplary embodiment. Method 500 may include steps S502-S518 as described below. It is to be appreciated that some of the steps may be optional to perform the disclosure provided herein. Further, some of the steps may be performed simultaneously, or in a different order than shown in FIG. 5. For description purpose, method 500 will be described as predicting the trajectory of vehicle 130 (as shown in FIG. 1) to aid autonomous driving decisions of vehicle 120 (as shown in FIG. 1). Method 500, however, can be implemented for other applications that can benefit from accurate predictions of vehicle trajectories.

In step S502, server 210 receives a map of the area vehicle 130 is traveling. In some embodiments, server 210 may determine the position of vehicle 120 based on, e.g., the GPS data collected by sensor 360, and identify a map area surrounding the position. If vehicle 130 is also connected with server 210 via a network, server 210 may alternatively identify the map area surrounding the GPS position of vehicle 130. Server 210 may receive the relevant 3-D map data, e.g., map data 403, from 3-D map database 240.

In step S504, server 210 receives the sensor data capturing vehicle 130 and surrounding objects. In some embodiments, the sensor data may be captured by various sensors such as sensors 220 installed along the roads and/or sensors 230 (including, e.g., sensors 340-360) equipped on vehicle 120. The sensor data may include vehicle speed acquired by a speedometer, images (including video images) acquired by cameras, point cloud data acquired by a LiDAR, etc. In some embodiments, the sensor data may be captured over time to track the movement of vehicle 130 and surrounding objects. The sensors may communicate with server 210 via a network to transmit the sensor data, e.g., sensor data 401, continuously, or regularly, or intermittently.

Method 500 proceeds to step S506, where server 210 positions vehicle 130 in the map. In some embodiments, the point cloud data captured of vehicle 130, e.g., by sensor 340, may be matched with map data 403 to determine the vehicle's position in the map. In some embodiments, positioning methods such as SLAM may be used to position vehicle 130. In some embodiments, the positions of vehicle 130 at different time points may be labeled on map data 403 to trace the prior trajectory and moving speed of the vehicle. Labeling of the point cloud data may be performed by server 210 automatically or with human assistance.

In step S508, server 210 identifies other objects surrounding vehicle 130. Features of such objects may provide additional information useful for predicting the trajectory of vehicle 130. For example, these objects may include, e.g., traffic lights 104, traffic signs, lane markings, and other vehicles at cross-road 100, etc. In some embodiments, various image processing methods and machine learning methods may be implemented to identify the objects.

In step S510, server 210 extracts features of vehicle 130 and its surrounding objects from sensor data 401 and map data 403. In some embodiments, the features extracted may include semantical or non-semantical that are indicative of future trajectory of the vehicle. For example, extracted features of vehicle 130 may include, e.g., the vehicle speed, the vehicle heading direction, vehicle turn signals, vehicle braking signals, etc. Extracted features of surrounding objects may include, e.g., the lane markings of vehicle lane (indicating a travel restriction of the lane), the status of the traffic light (including the type of light that is on and the color of the light), and information on the traffic signs. In some embodiments, various feature extraction methods including image processing methods and machine learning methods may be implemented.

In step S512, server 210 determines multiple candidate trajectories for vehicle 130. Candidate trajectories are possible trajectories vehicle 130 may follow. For example, vehicle 130 may follow one of the four candidate trajectories 151-154 (shown in FIG. 1), i.e., to turn right, go straight, turn left, or make a U-turn at cross-road 100. In some embodiments, server 210 may remove one or more candidate trajectories that conflicts with any of the features. This optional filtering step may help simplify the prediction task and conserve processing power of server 210. For example, if the vehicle is on a lane with right-turn only lane marking, and the vehicle is signaling a right-turn, a left-turn trajectory and a U-turn trajectory may be eliminated since the probability that the vehicle will turn left or make a U-turn under such conditions is substantially low.

Method 500 proceeds to step S514 to determine a probability for each candidate trajectory. In some embodiments, server 210 may apply learning model 405 for the prediction. In some embodiments, learning model 405 may be a predictive model, such as a decision tree learning model. For example, learning model 405 may be a Gradient Boosting Decision Tree model. In some embodiments, learning model 405 may be trained using known vehicle trajectories and their respective sample features. In step S514, learning model 405 may be applied to determine a probability for each candidate trajectory based on the extracted features. For example, it may be determined that vehicle 130 has a 10% probability to follow candidate trajectory 151 to make a right-turn, 50% probability to follow candidate trajectory 152 to go straight, 30% probability to follow candidate trajectory 153 to make a left-turn, and 10% probability to follow candidate trajectory 154 to make a U-turn.

In step S516, server 210 may compare the probabilities with a predetermined threshold. In some embodiments, the predetermined threshold may be a percentage higher than 50%, such as 60%, 70%, 80%, or 90%. If no probability is higher than the threshold (S516: No), the prediction may be considered unreliable. In some embodiments, method 500 may return to step S504 to receive additional sensor data to improve the prediction. In some embodiments, server 210 may determine what additional sensor data can be acquired and generate control signals to direct sensors 220 and/or 230 to capture the additional data to be received in step S504.

If at least the highest probability is higher than the threshold (S516: Yes), server 210 may predict the vehicle trajectory in step S518 by selecting the corresponding candidate trajectory from the candidate trajectories. In some embodiments, the candidate trajectory with the highest probability may be identified as the predicted trajectory of the vehicle. For example, candidate trajectory 152 may be selected as the predicted trajectory of vehicle 130 when it has the highest probability.

The prediction result provided by method 500 may be used to aid vehicle controls or driver's driving decisions. For example, an autonomous vehicle may make automated control decisions based on the predicted trajectories of other moving vehicles in order not to collide with them. The prediction may also be used to help alerting a driver to adjust his intended driving path and/or speed to avoid collision. For example, audio alerts such as beeping may be provided.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for predicting a trajectory of a vehicle, comprising:
a communication interface configured to receive a map of an area in which the vehicle is traveling and sensor data acquired associated with the vehicle; and
at least one processor configured to:
position the vehicle in the map;
identify one or more objects surrounding the vehicle based on the positioning of the vehicle;
extract features of the vehicle and the one or more objects from the sensor data;
determine a plurality of candidate trajectories;
determine a probability for each candidate trajectory based on the extracted features; and
identify the candidate trajectory with the highest probability as the predicted trajectory of the vehicle.

2. The system of claim 1, wherein the probability for each candidate trajectory is determined using a learning model trained with known vehicle trajectories and their respective sample features.

3. The system of claim 2, wherein the learning model is a Gradient Boosting Decision Tree.

4. The system of claim 1, wherein the sensor data include point cloud data acquired by a LiDAR.

5. The system of claim 1, wherein the sensor data includes images acquired by a camera.

6. The system of claim 1, wherein the at least one processor is further configured to:
label a prior trajectory of the vehicle on the map based on the positioning of the vehicle at previous times; and
determine the probability of each candidate trajectory based additionally on the labeled prior trajectory.

7. The system of claim 1, wherein the one or more objects include a traffic light that the vehicle is facing, wherein to extract the features, the at least one processor is further configured to determine a type of light that is on in the traffic light and a color of the light.

8. The system of claim 1, wherein the one or more objects include a lane on which the vehicle is traveling, wherein to extract the features, the at least one processor is further configured to detect a lane marking of the lane.

9. The system of claim 1, wherein to extract the features of the vehicle, the at least one processor is further configured to determine a heading direction, a speed, a turn signal, or a braking signal of the vehicle.

10. The system of claim 1, wherein the at least one processor is further configured to:
remove a candidate trajectory that conflicts with any of the features.

11. A method for predicting a trajectory of a vehicle, comprising:
receiving, by a communication interface, a map of an area in which the vehicle is traveling and sensor data acquired associated with the vehicle;
positioning, by at least one processor, the vehicle in the map;
identifying, by the at least one processor, one or more objects surrounding the vehicle based on the positioning of the vehicle;
extracting, by the at least one processor, features of the vehicle and the one or more objects from the sensor data;
determining, by the at least one processor, a plurality of candidate trajectories;
determining, by the at least one processor, a probability for each candidate trajectory based on the extracted features; and
identifying the candidate trajectory with the highest probability as the predicted trajectory of the vehicle.

12. The method of claim 11, further comprising:
determining the probability for each candidate trajectory using a Gradient Boosting Decision Tree learning model trained with known vehicle trajectories and their respective sample features.

13. The method of claim 11, wherein the sensor data include point cloud data acquired by a LiDAR and images acquired by a camera.

14. The method of claim 11, further comprising:
labeling a prior trajectory of the vehicle on the map based on the positioning of the vehicle at previous times; and
determining the probability of each candidate trajectory based additionally on the labeled prior trajectory.

15. The method of claim 11, wherein the one or more objects include a traffic light, wherein extracting the features further comprises determining a type of light that is on in the traffic light and a color of the light.

16. The method of claim 11, wherein the one or more objects include a lane on which the vehicle is traveling wherein extracting the features further comprises detecting a lane marking of the lane.

17. The method of claim 11, wherein extracting the features of the vehicle further comprises one or more of a heading direction, a speed, a turn signal, or a braking signal of the vehicle.

18. The method of claim 11, further comprising:
removing a candidate trajectory that conflicts with any of the features.

19. A non-transitory computer-readable medium having instructions stored thereon that, when executed by at least one processor, causes the at least one processor to perform operations comprising:
receiving a map of an area in which the vehicle is traveling and sensor data acquired associated with the vehicle;
positioning the vehicle in the map;
identifying one or more objects surrounding the vehicle based on the positioning of the vehicle;
extracting features of the vehicle and the one or more objects from the sensor data;
determining a plurality of candidate trajectories;
determining a probability for each candidate trajectory based on the extracted features; and
identifying the candidate trajectory with the highest probability as the predicted trajectory of the vehicle.

20. The computer-readable medium of claim 19, wherein extracting the features further comprises determining at least one of a heading direction, a speed, a turn light status, a brake light status of the vehicle, a traffic light status, or a lane marking of a lane on which the vehicle is traveling.
